(19) United States
(12) Patent Application Publication
(10) Pub. No.: US 2026/0300735 A1
(43) Pub. Date: Oct. 1, 2026

(54) TUNING SWITCH PERFORMANCE PARAMETERS USING NEURAL NETWORKS

(71) Applicant: Microchip Touch Solutions Limited, Wokingham (GB)

(72) Inventor: Richard Jonathan Petrie, Guildford (GB)

(73) Assignee: Microchip Touch Solutions Limited, Wokingham (GB)

(21) Appl. No.: 19/263,965

(22) Filed: Jul. 9, 2025

Related U.S. Application Data
(60) Provisional application No. 63/779,419, filed on Mar. 28, 2025.

(51) Int. Cl. G06N 3/084; G06N 3/0475

(52) U.S. Cl. CPC G06N 3/084; G06N 3/0475

(57) ABSTRACT

Devices, computer-readable storage mediums, and methods tune performance parameters using one or more artificial intelligence models by monitoring data packets being received by a device, the data packets including one or more data characteristics, predicting, using the one or more artificial intelligence models, future data traffic patterns of the data packets, the predicting including categorizing the one or more data characteristics of the data packets, identifying, based on the predicted future data traffic patterns, one or more tuning parameters to improve bandwidth or reduce latency of the future data traffic patterns, and modifying one or more configurable parameters of the device to include the one or more tuning parameters.

### CROSS-REFERENCE TO RELATED APPLICATION

The present application claims priority from U.S. Provisional Patent Application No. 63/779,419, filed on Mar. 28, 2025, which is incorporated herein by reference in its entirety.

### TECHNICAL FIELD

The present disclosure relates generally to neural networks, and more specifically to systems, devices, and methods for tuning switch performance parameters using neural networks.

### SUMMARY

According to an aspect of one or more examples, there is provided a device to direct variable bandwidth data traffic to one or more peripheral devices, at least one processor, and a non-transitory computer-readable storage medium. The non-transitory computer-readable storage medium may store instructions that, when executed by the at least one processor, cause the at least one processor to monitor data packets being received by the device, the data packets including one or more data characteristics. Future data traffic patterns of the data packets may be predicted using the one or more artificial intelligence models, where the predicting includes categorizing the one or more data characteristics of the data packets. Based on the predicted future data traffic patterns, one or more tuning parameters to improve bandwidth or reduce latency of the future data traffic patterns may be identified. One or more configurable parameters of the device may be modified to include the one or more tuning parameters, the modifying directing variable bandwidth data traffic to one or more peripheral devices.

The one or more artificial intelligence models may include one or more large language models, and the one or more data characteristics of the data packets may include a textual representation of the variable bandwidth data traffic that may be inserted into the one or more large language models. The one or more large language models may tokenize the textual representation of the variable bandwidth data traffic to generate tokens and may map the tokens to a numerical vector, where the numerical vector may be applied to one or more large language models and propagated through multiple layers of the one or more large language models to perform the categorizing of the one or more data characteristics. The multiple layers of the one or more large language models may include multiple interconnected nodes that perform transformations to process inputs using a weighted sum to apply weights to the one or more data characteristics and an activation function to produce one or more outputs, where the one or more outputs may include the one or more tuning parameters. The one or more outputs may be compared to one or more desired outputs and a loss function may be used to quantify a difference between the one or more outputs and the one or more desired outputs, where the difference may be associated with an error value. The one or more large language models may be retrained using backpropagation of the error value, the retraining may include adjusting the weights applied to the one or more data characteristics.

The one or more artificial intelligence models may be unsupervised or supervised. The device may include one of a PCIe switch, an Ethernet switch, a USB switch, or a computing hub. The one or more configurable parameters may include at least one of a buffer number, a buffer size, a buffer threshold, a bandwidth throttling level, or a permitted packet size. The one or more configurable parameters may be dynamically modified in real time while the data packets are being received by the device. The device may include a plurality of channels and the one or more configurable parameters may apply to one or more of the plurality of channels. The one or more artificial intelligence models may be trained using training data and the one or more artificial intelligence models may be iteratively trained prior to deployment. The one or more configurable parameters may be modified based on the predicting satisfying a confidence threshold that the data packets being received by the device are indicative of the future data traffic patterns of the data packets. The bandwidth or the latency may be preselected, and an inverse function may be used during the predicting of the future data traffic patterns to perform the identifying of the one or more tuning parameters that correspond to the preselected bandwidth or the preselected latency.

According to an aspect of one or more examples, there is provided a non-transitory computer-readable storage medium to store instructions. When executed by the at least one processor, the instructions may cause the at least one processor to monitor data packets being received by a device and directed to one or more peripheral devices, the data packets including one or more data characteristics. Using one or more artificial intelligence models, future data traffic patterns of the data packets may be predicted, where the predicting may include categorizing the one or more data characteristics of the data packets. Based on the predicted future data traffic patterns, one or more tuning parameters to improve bandwidth or reduce latency of the future data traffic patterns may be identified. One or more configurable parameters of the device may be modified to include the one or more tuning parameters.

The one or more artificial intelligence models may include one or more large language models and the one or more data characteristics of the data packets include a textual representation of variable bandwidth data traffic that is inserted into the one or more large language models. The one or more large language models may tokenize the textual representation of the variable bandwidth data traffic to generate tokens and may map the tokens to a numerical vector, where the numerical vector may be applied to the one or more large language models and propagated through multiple layers of the one or more large language models to perform the categorizing of the one or more data characteristics. The device may include one of a PCIe switch, an Ethernet switch, a USB switch, or a computing hub.

According to an aspect of one or more examples, there is provided a method to tune device performance parameters using one or more artificial intelligence models. The method may include monitoring data packets being received by a device, the data packets including one or more data characteristics. The method may also include predicting, using the one or more artificial intelligence models, future data traffic patterns of the data packets, the predicting including categorizing the one or more data characteristics of the data packets. Further, the method may include identifying, based on the predicted future data traffic patterns, one or more tuning parameters to improve bandwidth or reduce latency of the future data traffic patterns. In addition, the method may include modifying one or more configurable parameters of the device to include the one or more tuning parameters.

### BRIEF DESCRIPTION OF DRAWINGS

FIG. 1 is a diagram illustrating a system for training a large language model to tune switch performance parameters, according to one or more examples.

FIG. 2 is a diagram illustrating a system for using a large language model to tune switch performance parameters, according to one or more examples.

FIG. 3 shows a diagram illustrating a system for training a large language model using switch performance parameters as well as other data, according to one or more examples.

FIG. 4 shows a flowchart illustrating a method for tuning device performance parameters using one or more artificial intelligence models, according to one or more examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be exemplified in various forms without being limited to the examples set forth herein.

Switches, such as peripheral component interconnect express (PCIe) switches, ethernet switches, universal serial bus (USB) switches, and various other types of switches have several fixed parameters that affect bandwidth and latency of transmission of data packets of a data stream that may be received and distributed. For example, a PCIe switch may determine which devices may be connected to a circuit board, ascertain the links connecting various devices that may be coupled to the circuit board, generate a map for directing network traffic, and determine the number of lanes to be actively used to transmit and receive data. A PCIe switch actively routes traffic between multiple devices that may be connected to a single PCIe port. Ethernet switches, in coordination with virtual local area networks (LANs) may transmit data packets by identifying a media access control (MAC) address for the destination of the data packet, cross-reference the MAC address to a table, and direct the data packet to the appropriate destination. USB switches may route data packets from a common port to a selected channel where the channel that is selected may receive the full bandwidth of the host.

In contrast to a PCIe switch, a PCIe hub may utilize “signal splitting” to split a single PCIe signal into multiple signals so that multiple devices may be connected to a single PCIe port. In contrast to an Ethernet switch, which directs data packets to an intended recipient based on a MAC address, an Ethernet hub may broadcast data to all connected ports. Also, in contrast to a USB switch, a USB hub may take an upstream-facing connection and share it concurrently with multiple downstream devices.

Switches or hubs may include one or more integrated processors for data packet processing. The one or more integrated processors may direct variable bandwidth data traffic to one or more peripheral devices. Such peripheral devices may include cameras, printers, or various other computing devices.

The systems, devices, and methods disclosed herein may provide an advantage over existing switches and hubs, such as PCIe switches and hubs, Ethernet switches and hubs, USB switches and hubs, and various other switches and hubs, by tuning configurable parameters of the switches and hubs in accordance with a prediction of bandwidth improvement and latency reduction. In particular, the systems, devices, and methods may be used for any switch or hub where there is variable bandwidth and traffic being routed from one or more sources to one or more destinations.

For example, neural networks disclosed herein may be trained to predict parameters for improved bandwidth and reduced latency based on characteristics of the input data being received for variable traffic loads. The neural network may be trained using training data and a feedback mechanism to iteratively revise the prediction. Once trained, the neural networks may be deployed and used to dynamically tune one or more configurable parameters of a device (e.g., a switch or hub) based on the characteristics of the input data being received within a data stream. For example, the device may be tuned to dynamically modify buffer thresholds, buffer numbers, buffer sizes, bandwidth throttling levels, permitted packet sizes, and various other parameters. Rather than configuring the device with a static set of parameters in an ad hoc manner, the parameters in the device may be dynamic in order to adjust, in real time, to characteristics of the input data stream.

Firmware may be embedded into a device to control basic functions of the device, and the firmware may utilize an artificial intelligence model such as a neural network, and in various examples the neural network may include a large language model, to characterize input data and predict parameters that may produce improved bandwidth or reduced latency. The device may then be dynamically tuned, in real time, based on the predicted parameters in order to improve the bandwidth or reduce the latency in accordance with characteristics of the input data being received. For example, the characteristics of the data stream may include a high quantity of small packets, a few large packets, large gaps between data inputs, a continual data stream without any gaps in the data inputs, or various other characteristics, and these characteristics may be variable throughout the data stream. Advantageously, the systems, devices, and methods disclosed herein may dynamically tune the parameters of the device (e.g., a switch or hub) in accordance with the changing characteristics of the data stream.

An artificial intelligence model may refer to computer-implemented programs that simulate intelligent behavior and may be operatively coupled with firmware to control functionality of the hardware of a device. In various examples, artificial intelligence models may include a series of if-then logic statements and may map data into categories. Artificial intelligence models may include a machine learning program that may iteratively adjust aspects of the artificial intelligence model based on information learned from data that is input into the artificial intelligence model. A machine learning program may implement various algorithmic processes and learning approaches utilizing, for example, decision tree learning, association rule learning, artificial neural networks, recurrent neural networks, inductive logic programming, support vector machines, k-nearest neighbor, or various other approaches. The artificial intelligence models may include supervised learning utilizing decision tree learning, support vector machines, similarity and metric learning, or various other supervised learning processes. Alternatively, the artificial intelligence models may include unsupervised learning utilizing association rule learning, clustering, or various other unsupervised learning processes. Supervised learning processes may utilize identified inputs and identified outputs that are categorized and classified to predict a quality of a future input. Supervised learning processes may utilize content data that is labeled or “tagged.” During training, supervised learning processes may learn the most proximate mapping function between an identified data input and an expected output and then uses the most proximate mapping learned during training to predict the corresponding output. In contrast, in unsupervised learning some of the outputs may be unknown or all of the outputs may be unknown, and the training may be performed on unlabeled data.

Artificial intelligence models that incorporate neural networks may include connected units, which may be referred to as neurons or nodes, and the units may be connected by synapses. Example neural networks may incorporate machine learning and may include feedforward artificial neural networks, perceptron and multilayer perceptron neural networks, radial basis function artificial neural networks, recurrent artificial neural networks, modular neural networks, long short-term memory networks, as well as various other neural networks.

In various examples, a PCIe switch may route data traffic and may include a direct memory access (DMA) engine that may perform a memory transfer between one port and another port (e.g., a configuration in which two computers may be connected to the PCIe switch). The DMA engine of the PCIe switch may be tuned, in accordance with the characteristics of the data stream, and parameters of one channel or potentially multiple channels of the DMA may be modified.

The process of predicting the improved parameters, or the parameters that would reduce latency, may monitor the data packets being received by a device, evaluate one or more data characteristics of the data packets, and predict characteristics of incoming data that is likely to pass through the device. For example, a large language model may be trained to predict traffic patterns in a data stream based on the current data traffic correlating with past traffic patterns. As input data of a data stream is received, the large language model may predict the characteristics of future incoming data and dynamically modify the parameters of the device to improve bandwidth and reduce latency in accordance with the predicted characteristics of the future incoming data.

In various examples, one or more artificial intelligence models may be used in design of the device (e.g., the switch or hub) itself to identify desired configurations of the device prior to incorporating the hardware and firmware into the device. For example, if characteristics of the data for a given use case are pre-identified prior to configuring the device, the artificial intelligence models may be used to predict future data traffic patterns of data packets for the given use case and the parameters of the hardware and firmware of the device may be adjusted accordingly to reduce the memory footprint and improve the processing power of the processor.

In various examples, the training data used to train the artificial intelligence model may include many different characteristics of a data stream and information about how the characteristics impact bandwidth and latency. In addition, various parameters of the device may be associated with the different characteristics such that if certain characteristics are present then certain parameters are identified as having the relatively greatest improvement on bandwidth or greatest reduction in latency. In examples in which the one or more artificial intelligence models include a neural network, these characteristics may correspond to certain weights that are applied to the nodes of the neural network. The weights may correspond to the strength of connections between nodes of the neural network and may impact how much influence one node's output has on another node. The weights may define the impact a node in a given layer of a multilayered neural network may have on computations by a connected node in the next layer. The weights may be adjusted using backpropagation that may include a loss function that compares a difference between a target prediction and the actual prediction, and the weights are adjusted to reduce the difference between the target prediction and the actual prediction. During training of the artificial intelligence model, the weights may be iteratively adjusted until any error in the output data of the actual prediction, when compared to a correct output of the target prediction, is less than a predetermined, acceptable level. The error that may be identified may include an overall error or may include an error in an output layer of a multilayered neural network (e.g., a multilayer perceptron). The error may be communicated back, using a feedback loop, through the neural network as an error signal in order to cause the weights assigned to the nodes to be adjusted. In various examples, the iterative training process may be continued until each node within each layer of the multilayered neural network includes an error amount that may be less than the predetermined, acceptable level.

Example neural networks may include artificial neural networks that include nodes arranged in layers with a hidden layer positioned between an input layer and an output layer. The hidden layer may generate a representation or transformation of the input data into a format that is suitable for generating output data. The hidden layer may determine the state of the nodes in the respective layers and assign weights to the nodes based on an activation function implemented between the input data and the output data. Example neural networks may include convolutional neural networks that may include convolutional layers to extract features from input data, pooling layers to reduce spatial dimensions, and fully layers for performing a prediction. The nodes of convolutional neural networks may be organized into categories based on features and each node may output data to nodes of a corresponding subsequent layer of the convolutional neural networks. Example neural networks may also include recurrent neural networks that may utilize analysis of sequences of inputs rather than being limited by the current input data set. Recurrent neural networks may include feedback loops between layers of the neural network where past values of a node may influence a current calculation of the weight assigned to the node. Deep neural networks may include multiple hidden layers, where each of the hidden layers have differing numbers of nodes and connections between each layer and each of the hidden layers may perform a different function. The node of each hidden layer of the deep neural networks may be associated with an activation function to generate an output that is received by a corresponding node in the subsequent layer until the last hidden layer provides output data to the output layer.

The artificial intelligence models described herein may incorporate one or more support vector machines to determine how to categorize input data. The one or more support vector machines may determine a margin using a combination of input variables or data points to as support vectors to amplify the determined margin, where the margin may correspond to a distance between the closest vectors that have different classifications.

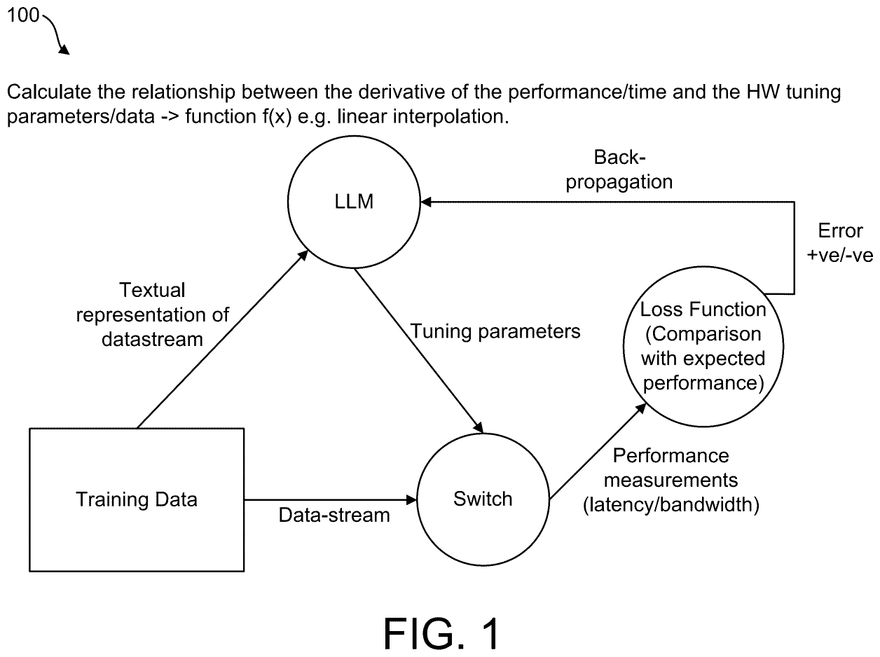

FIG. 1 is a diagram illustrating a system 100 for training a large language model to tune switch performance parameters, according to one or more examples. The large language model described herein may be trained, based on receiving a triggering input, to interpret a textual representation of a data stream. For example, the large language model may be used to perform statistical language modeling to predict a next textual representation in a string of text based on previous words. Further, input data used to train the large language model may be acquired through data ingestion. In various examples, the ingested data may be preprocessed by cleaning and transforming the data into a format for the large language model to digest. In various examples, the input data may be versioned so that each iteration of the large language model that is produced during the training is versioned. Training of the large language model may include data validation, which may include confirming that the data values of the ingested data are formatted as expected. Training data may include sample tokens, phrases, sentences, paragraphs, or documents. A target prediction may be inserted into the large language model and an iterative training and testing loop is activated to train the large language model. Application of the iterative training and testing loop may include making a prediction, testing the prediction by comparing a difference between the prediction and the target prediction to determine if the difference or error is below an acceptable amount. For example, the prediction may determine that the text associated with incoming data is most likely going to be associated with future data in a data stream that would benefit from an increase in the number of buffers that would improve performance of the switch before the data packets are forwarded to their destination. The text may be tokenized to include a series of data symbols (e.g., tokens) and other contextual information may be encoded, where the other contextual information may include various bit rates, gaps between packets, and various other contextual information. The large language model may include a 35% probability that the prediction is accurate, which may result in a 65% error rate. If the threshold applicable for the large language model to be considered sufficiently accurate is 70%, then the large language model is continually retrained until the probability increases to at least 70% and the error rate decreases to a number below 30%.

As part of the training process, if the incoming data include certain characteristics, tuning parameters may be provided to a simulated switch or a real switch. Once parameters of the simulated or real switch have been modified, the performance of the switch may be evaluated by measuring bandwidth or latency. For example, the relationship between the derivative of the performance or time associated with bandwidth or latency and the hardware tuning parameters may represent a function f(x) where “x” represents the data stream. A loss function is performed that includes comparing the actual performance of the modified switch, as represented by the function f(x), with expected performance to generate an error of +ve/−ve (i.e., positive/negative). In various examples, the switch's performance may be improved by plotting a straight line between the initial and final states of the large language model's features (e.g., the parameters of the weights) during training. The error may then be communicated back, using backpropagation to the large language model to retrain the large language model.

Various examples of large language models, such as those described herein, may be used to analyze text to form predictions. In various examples, a digital transformation of input data may be performed using various text processing techniques. Interpretation of the text may be performed by the various examples of large language models. The large language models may track how much memory, or the amount of processing time, is used to process the incoming data and the artificial intelligence models may be used to identify the parameters that improve bandwidth and reduce latency.

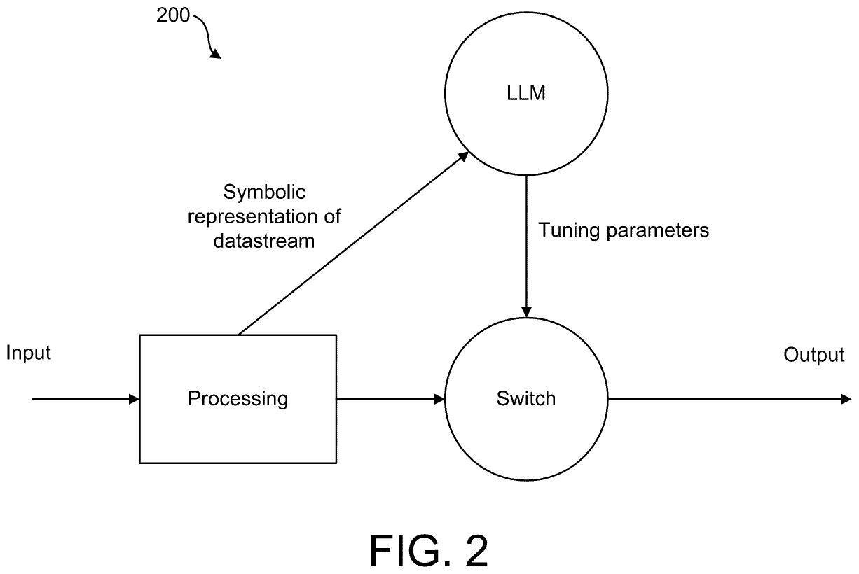

In various examples, once the large language model described above with reference to system 100 of FIG. 1 has been trained and the error is below an acceptable threshold, the large language model may be deployed. The switch referenced by FIGS. 1 and 2 may also be referred to herein as a device or a hub and may include a plurality of graphics processing units (GPUs) which may be processors used to perform parallel computations for training the artificial intelligence models (e.g., the large language model referenced by FIGS. 1 and 2).

FIG. 2 is a diagram illustrating a system 200 for using a large language model to tune switch performance parameters, according to one or more examples. The input data that is being processed and that is passing through the switch may be tokenized (e.g., encoded into tokens that may include a numerical representation) so that the trained large language model may interpret the incoming data. For example, the tokens of the input data may include a symbolic representation of the input data. The trained large language model may be used to predict a future state of incoming data and generate tuning parameters. For example, the large language model may be used to identify relationships and patterns in data from incoming data streams. This process of identifying the relationships and patterns may include an attention mechanism that allows tokens to focus on relevant parts of the input sequence so that the large language model may understand context and relationships between text. The switch may modify one or more configurable parameters to include the one or more tuning parameters that were identified from the large language model. The output of the switch may represent the state of the switch itself and the resultant bandwidth and latency. The output may also provide an input to inform the large language model and retrain the large language model.

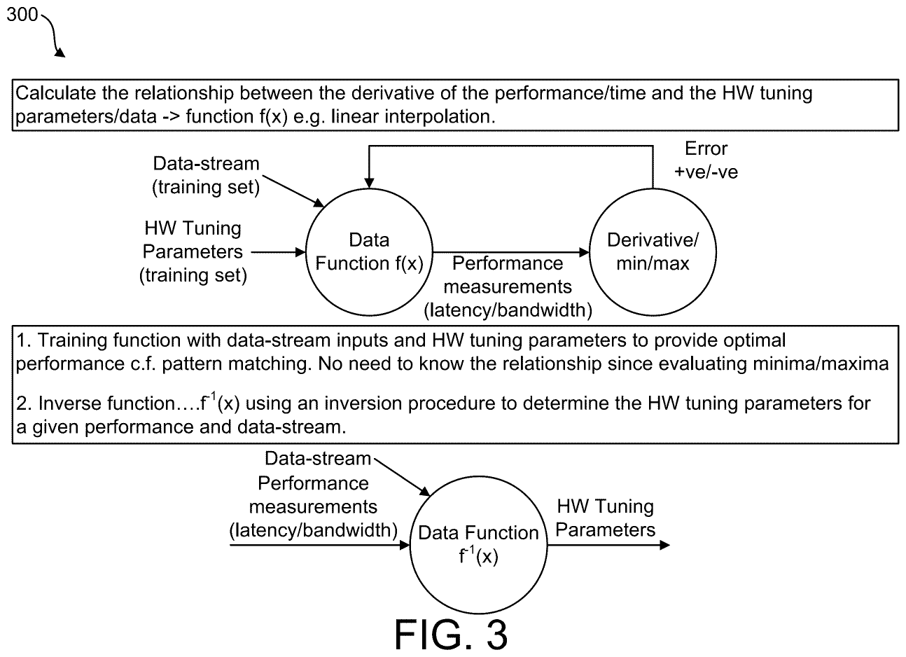

FIG. 3 shows a diagram illustrating a system 300 for training a large language model using switch performance parameters as well as other data, according to one or more examples. For example, the system 300 may utilize the performance parameters as well as the data as a training input to the artificial intelligence model. An inversion function f⁻¹(x) may be used during operation to extract desired parameters for given input data. For example, once an artificial intelligence model is trained, parameters for the hardware (HW) may be generated and the device may be modified to incorporate the parameters for the hardware that were predicted to improve bandwidth or reduce latency. That resulting function f(x) may be inverted in order to determine the hardware tuning parameters that would result in a desired performance for a given data stream. Thus, if the characteristics of the data stream are pre-identified, the inversion procedure (e.g., using the inversion function f⁻¹(x)) may be used to determine the parameters that would provide a desired performance level for the data stream (e.g., where the bandwidth and latency are preselected which may or may not directly correlate to improved bandwidth or reduced latency levels). In other words, the inputs to the artificial intelligence models include the desired bandwidth and the desired latency and those inputs are used to determine the parameters of the device that would facilitate generation of the desired bandwidth or desired latency. Advantageously, this process depicted by the system 300 of FIG. 3 may be used to design the device prior in order to accommodate data inputs in a manner that results in the desired bandwidth or the desired latency.

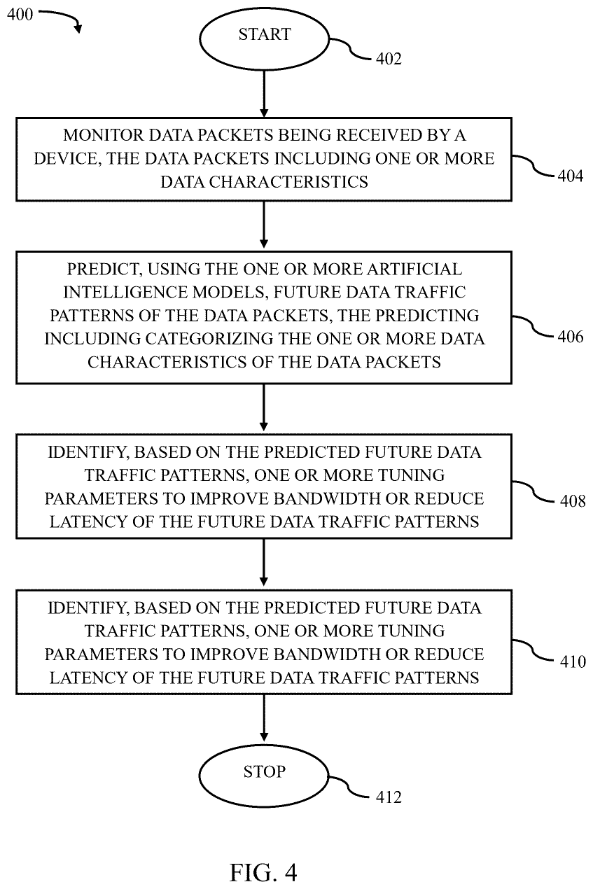

FIG. 4 shows a flowchart 400 illustrating a method for tuning device performance parameters using one or more artificial intelligence models, according to one or more examples. In various examples, an artificial intelligence model may include one or more large language models. In various examples, the artificial intelligence model may be supervised. In various examples, the artificial intelligence model may be unsupervised. The artificial intelligence model may be iteratively trained, using training data, prior to deployment. The flowchart 400 starts at operation 402. At operation 404, the method may include monitoring data packets being received by a device, the data packets including one or more data characteristics. The data characteristics of the data packets may include a textual representation of the variable bandwidth data traffic that is inserted into a large language model, which may act as the artificial intelligence model. The large language model may tokenize the textual representation of the variable bandwidth data traffic to generate tokens and may map the tokens to a numerical vector.

At operation 406, the method may include predicting, using the one or more artificial intelligence models, future data traffic patterns of the data packets, the predicting including categorizing the one or more data characteristics of the data packets. To perform operation 406, the one or more artificial intelligence models may be trained and deployed. The numerical vector may be applied to the large language model and propagated through multiple layers of the large language model to perform the categorizing of the one or more data characteristics. In various examples, the multiple layers of the large language model may include multiple interconnected nodes that perform transformations to process inputs using a weighted sum to apply weights to the one or more data characteristics and an activation function to produce one or more outputs, where the one or more outputs may include the one or more tuning parameters. Further, the one or more outputs may be compared to one or more desired outputs and a loss function may be used to quantify a difference between the one or more outputs and the one or more desired outputs. In addition, the difference may be associated with an error value and the large language model may be retrained using backpropagation of the error value. The retraining may include adjusting the weights applied to the one or more data characteristics.

At operation 408, the method may include identifying, based on the predicted future data traffic patterns, one or more tuning parameters to improve bandwidth or reduce latency of the future data traffic patterns. At operation 410, the method may include modifying one or more configurable parameters of a device to include the one or more tuning parameters. In various examples, the device may include a PCIe switch, an Ethernet switch, or a USB switch. In various examples, the device may include a computing hub. In various embodiments, the one or more configurable parameters may include at least one of a buffer number, a buffer size, a buffer threshold, a bandwidth throttling level, or a permitted packet size. In various embodiments, the one or more configurable parameters may be dynamically modified in real time while the data packets are being received by the device. In various embodiments, the device may include a plurality of channels for routing incoming data and the one or more configurable parameters may apply to one or more of the plurality of channels. The one or more configurable parameters may be modified based on the predicting satisfying a confidence threshold that the data packets being received by the device are indicative of the future data traffic patterns of the data packets. At operation 412, the method may stop.

In various examples, the bandwidth or the latency are preselected, and an inverse function is used during the predicting of the future data traffic patterns to perform the identifying of the one or more tuning parameters that correspond to the preselected bandwidth or the preselected latency.

Various examples have been disclosed herein, in connection with the above description and the drawings. It will be understood that it would be unduly repetitious to literally describe and illustrate all possible combinations or subcombinations of these examples. Accordingly, all examples may be combined in any way or combination, without limitation, and the present specification, including the drawings, shall be construed to constitute a complete written description of all combinations and subcombinations of these examples herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, the accompanying drawings are not to scale. A variety of modifications and variations are possible in light of the above teachings.

What is claimed is:

1. A device to tune device performance parameters using one or more artificial intelligence models, the system comprising:
at least one processor; and
a non-transitory computer-readable storage medium to store instructions that, when executed by the at least one processor, cause the at least one processor to:
monitor data packets being received, the data packets including one or more data characteristics;
predict, using the one or more artificial intelligence models, future data traffic patterns of the data packets, the predicting including categorizing the one or more data characteristics of the data packets;
identify, based on the predicted future data traffic patterns, one or more tuning parameters to improve bandwidth or reduce latency of the future data traffic patterns; and
modify one or more configurable parameters to include the one or more tuning parameters, the modifying directing variable bandwidth data traffic to one or more peripheral devices.

2. The device of claim 1, wherein the one or more artificial intelligence models include one or more large language models, and the one or more data characteristics of the data packets include a textual representation of the variable bandwidth data traffic that is inserted into the one or more large language models.

3. The device of claim 2, wherein the one or more large language models tokenize the textual representation of the variable bandwidth data traffic to generate tokens and to map the tokens to a numerical vector, where the numerical vector is applied to the one or more large language models and propagated through multiple layers of the one or more large language models to perform the categorizing of the one or more data characteristics.

4. The device of claim 3, wherein the multiple layers of the one or more large language models include multiple interconnected nodes that perform transformations to process inputs using a weighted sum to apply weights to the one or more data characteristics and an activation function to produce one or more outputs, the one or more outputs including the one or more tuning parameters.

5. The device of claim 4, wherein the one or more outputs are compared to one or more desired outputs and a loss function is used to quantify a difference between the one or more outputs and the one or more desired outputs, wherein the difference is associated with an error value wherein the one or more large language models are retrained using backpropagation of the error value, the retraining comprises adjusting the weights applied to the one or more data characteristics.

6. The device of claim 1, wherein the one or more artificial intelligence models are unsupervised.

7. The device of claim 1, wherein the one or more artificial intelligence models are supervised.

8. The device of claim 1, further comprising one of a PCIe switch, an Ethernet switch, or a USB switch.

9. The device of claim 1, further comprising a computing hub.

10. The device of claim 1, wherein the one or more configurable parameters comprise at least one of a buffer number, a buffer size, a buffer threshold, a bandwidth throttling level, or a permitted packet size.

11. The device of claim 1, wherein the one or more configurable parameters are dynamically modified in real time while the data packets are being received.

12. The device of claim 1, further comprising a plurality of channels and the one or more configurable parameters apply to one or more of the plurality of channels.

13. The device of claim 1, wherein the one or more artificial intelligence models are trained using training data, wherein the one or more artificial intelligence models are iteratively trained prior to deployment.

14. The device of claim 1, wherein the one or more configurable parameters are modified based on the predicting satisfying a confidence threshold that the data packets being received are indicative of the future data traffic patterns of the data packets.

15. The device of claim 1, wherein the bandwidth or the latency are preselected, and an inverse function is used during the predicting of the future data traffic patterns to perform the identifying of the one or more tuning parameters that correspond to the preselected bandwidth or the preselected latency.

16. A non-transitory computer readable storage medium, the computer-readable storage medium storing instructions that when executed by a processor cause the processor to:
monitor data packets being received by a device and directed to one or more peripheral devices, the data packets including one or more data characteristics;
predict, using one or more artificial intelligence models, future data traffic patterns of the data packets, the predicting including categorizing the one or more data characteristics of the data packets;
identify, based on the predicted future data traffic patterns, one or more tuning parameters to improve bandwidth or reduce latency of the future data traffic patterns; and
modify one or more configurable parameters of the device to include the one or more tuning parameters.

17. The computer readable storage medium of claim 16, wherein the one or more artificial intelligence models include one or more large language models, and the one or more data characteristics of the data packets include a textual representation of variable bandwidth data traffic that is inserted into the one or more large language models.

18. The computer readable storage medium of claim 17, wherein the one or more large language models tokenize the textual representation of the variable bandwidth data traffic to generate tokens and to map the tokens to a numerical vector, where the numerical vector is applied to the one or more large language models and propagated through multiple layers of the one or more large language models to perform the categorizing of the one or more data characteristics.

19. The computer readable storage medium of claim 17, wherein the device comprises one of a PCIe switch, an Ethernet switch, a USB switch, or a computing hub.

20. A method to tune device performance parameters using one or more artificial intelligence models, the method comprising:
monitoring data packets being received by a device, the data packets including one or more data characteristics;
predicting, using the one or more artificial intelligence models, future data traffic patterns of the data packets, the predicting including categorizing the one or more data characteristics of the data packets;
identifying, based on the predicted future data traffic patterns, one or more tuning parameters to improve bandwidth or reduce latency of the future data traffic patterns; and
modifying one or more configurable parameters of the device to include the one or more tuning parameters.
